(19) United States
(12) Patent Application Publication
(10) Pub. No.: US 2024/0332540 A1
(43) Pub. Date: Oct. 3, 2024

(54) METALLIZED POLYMER CURRENT COLLECTOR-TO-TAB WELDED CONNECTION

(71) Applicant: Our Next Energy, Inc., Novi, MI (US)

(72) Inventors: Qingcheng Zeng, San Jose, CA (US); Peyman Sirous, San Jose, CA (US)

(21) Appl. No.: 18/622,520

(22) Filed: Mar. 29, 2024

Related U.S. Application Data
(60) Provisional application No. 63/493,259, filed on Mar. 30, 2023.

(51) Int. Cl. H01M 4/66; H01M 50/536

(52) U.S. Cl. CPC H01M 4/667; H01M 50/536

(57) ABSTRACT

An article including a first active material layer, a second active material layer positioned opposite the first active material layer, a polymer current collector layer positioned between the first active material layer and the second active material layer, and projecting beyond a first edge of the first and second active material layers. In the article, a first metal layer is welded to a first side of the polymer current collector layer at a first welding zone, a second metal layer is welded to a second side of the polymer current collector layer opposite the first side at the first welding zone, and an extension of one of the metal layers that is longer is welded to the other metal layer at a second welding zone that is opposite the first welding zone and on a side of the first welding zone that is away from the first edge.

### BACKGROUND

### Technical Field

The present disclosure generally relates to welded connection between a current collector and a tab and more particularly to an improvement in a weld connecting a current collector to a tab of in an electrode stack.

### Description of the Related Art

Many products such as electric vehicles (EV) and energy storage systems include batteries that are used to supply energy. Batteries may have different architectures and components based on use case. A typical electric vehicle battery, for example, may be decomposed into a cell level, a module level, and a pack level. Anodes and cathodes are the primary components of a cell, while multiple cells and modules may be combined to form a pack.

In many battery cells, for example in a lithium-ion battery cell, the current collector-to-tab, tab-to-tab, and tab-to-bus joints may be the three most typical connections. While there may be difficulties in forming the joints in all three connections, welding one or more layers of a current collector to a tab may be the most difficult. Frequently, joints are often made up of dissimilar metals with material thickness mismatches which may lead to difficulties in generating robust welded connections.

### BRIEF SUMMARY

According to an embodiment of the present disclosure, an article including a polymer current collector-to-tab welded connection is disclosed. The article includes a first active material layer, a second active material layer positioned opposite the first active material layer, a polymer current collector layer positioned between the first active material layer and the second active material layer, and projecting beyond a first edge of the first and second active material layers. In the article, a first metal layer is welded to a first side of the polymer current collector layer at a first welding zone, a second metal layer is welded to a second side of the polymer current collector layer opposite the first side at the first welding zone, and an extension of the longer of the first and second metal layers is welded to shorter of the first and second metal layers at a second welding zone that is opposite the first welding zone and on a side of the first welding zone that is away from the first edge. The extension may be a unibody extension of the second metal layer and thus the second metal layer may be longer than the first metal layer in one embodiment.

In one embodiment, the first metal layer and the second metal layer are welded to the polymer current collector layer at the first welding zone by roll ultrasonic welding or another type of roll welding/bonding technique to form a rolling weld.

In one embodiment, the first metal layer and the second metal layer are welded together at the second welding zone by resistance welding, spot ultrasonic welding, roll ultrasonic welding or laser welding to form a resistance weld, a spot ultrasonic weld, a roll ultrasonic weld or a laser weld respectively.

According to an embodiment of the present disclosure, a method of forming the polymer current collector-to-tab welded connection is disclosed. In the method a first active material layer of a cell is provided, a second active material layer of the cell is provided and disposed opposite the first active material layer, and a polymer current collector layer is placed in between the first active material layer and the second active material layer to contact both the first active material layer and the second active material layer. The polymer current collector layer projects beyond a first edge of the first and second active material layers. In the method, a first welding process is performed in which a first metal layer is welded to a first side of the polymer current collector layer at a first welding zone, and a second metal layer is welded to a second side of the polymer current collector layer opposite the first side at the first welding zone. In a second welding process, an extension of the longer of the first and second metal layers may be welded the shorter of the first and second metal layers at a second welding zone that is opposite the first welding zone and on a side of the first welding zone that is away from the first edge.

In one embodiment, an electrode that includes at least the tab, the first active material layer, the second active material layer, and the polymer current collector layer is formed by a cutting process based on a desired shape and/or dimensions of the electrode.

### BRIEF DESCRIPTION OF THE DRAWINGS

To easily identify the discussion of any particular element or act, the most significant digit or digits in a reference number refer to the figure number in which that element is first introduced.

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all the components or steps that are illustrated. When the same numeral appears in different drawings, it refers to the same or like components or steps

FIG. 1 depicts a top view of a welding system in which illustrative embodiments may be implemented.

FIG. 2 depicts a cross-section view of a welding system in which illustrative embodiments may be implemented.

FIG. 3 depicts a cross-section view of a polymer current collector-to-tab welded connection in which illustrative embodiments may be implemented.

FIG. 4 depicts a routine in which illustrative embodiments may be implemented.

FIG. 5 depicts a top view of an electrode in which illustrative embodiments may be implemented.

FIG. 6 depicts a cross-section view of an electrode stack in which illustrative embodiments may be implemented.

FIG. 7 depicts a cross-section view of a pouch in which illustrative embodiments may be implemented.

FIG. 8 depicts a functional block diagram of a computer hardware platform in accordance with one embodiment.

### DETAILED DESCRIPTION

### Overview

In the following detailed description, numerous specific details are set forth by way of examples to provide a thorough understanding of the relevant teachings. However, it should be apparent that the present teachings may be practiced without such details. In other instances, well-known methods, procedures, and/or components have been described at a relatively high-level, without detail, to avoid unnecessarily obscuring aspects of the present teachings.

In one aspect, spatially related terminology such as “front,” “back,” “top,” “bottom,” “beneath,” “below,” “lower,” “above,” “upper,” “side,” “left,” “right,” and the like, is used with reference to the orientation of the Figures being described. Since components of embodiments of the disclosure can be positioned in a number of different orientations, the directional terminology is used for purposes of illustration and is in no way limiting. Thus, it will be understood that the spatially relative terminology is intended to encompass different orientations of the device in use or operation in addition to the orientation depicted in the figures. For example, if the device in the figures is turned over, elements described as “below” or “beneath” other elements or features would then be oriented “above” the other elements or features. Thus, for example, the term “below” can encompass both an orientation that is above, as well as, below. The device may be otherwise oriented (rotated 90 degrees or viewed or referenced at other orientations) and the spatially relative descriptors used herein should be interpreted accordingly.

As used herein, the terms “lateral” and “horizontal” describe an orientation parallel to a first surface of a cell. As used herein, the term “vertical” describes an orientation that is arranged perpendicular to the first surface of a cell.

As used herein, the terms “coupled” and/or “electrically coupled” are not meant to mean that the elements must be directly coupled together-intervening elements may be provided between the “coupled” or “electrically coupled” elements. In contrast, if an element is referred to as being “directly connected” or “directly coupled” to another element, there are no intervening elements present. The term “electrically connected” refers to an electric connection between the elements electrically connected together.

Although the terms first, second, etc., may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

Example embodiments are described herein with reference to cross-sectional illustrations that are schematic illustrations of idealized or simplified embodiments (and intermediate structures). As such, variations from the shapes of the illustrations as a result, for example, of manufacturing techniques and/or tolerances, may be expected. Thus, the regions illustrated in the figures are schematic in nature and their shapes do not necessarily illustrate the actual shape of a region of a device and do not limit the scope.

It is to be understood that other embodiments may be used, and structural or logical changes may be made without departing from the spirit and scope defined by the claims. The description of the embodiments is not limiting. In particular, elements of the embodiments described hereinafter may be combined with elements of different embodiments.

For the sake of brevity, conventional techniques related to battery cells and their fabrication may or may not be described in detail herein. Moreover, the various tasks and process steps described herein can be incorporated into a more comprehensive procedure or process having additional steps or functionality not described in detail herein. In particular, various steps in the manufacture of cells are well known and so, in the interest of brevity, many conventional steps will only be mentioned briefly herein or will be omitted entirely without providing the well-known process details.

Turning now to an overview of technologies that generally relate to the present teachings, it is recognized that one of the most important processes in the creation of batteries or other electrochemical devices is the connection of a current collector of an electrode to a tab. The tab, which connects the electrode to the external circuit, may typically be a thin metal band that serves as a point of contact for the electrode. To facilitate the charging and discharging process, the current collector is electrically connected to the tab. A method for accomplishing this may be to weld or bind the current collector to the tab. Depending on the type of current collector and tab materials used, as well as the manufacturing process, a specific technique may be used.

It is recognized that current conductors containing metal may be connected to tabs through the process of welding. Different welding processes may be used to accomplish this. For example, resistance welding may use electrical resistance to heat the materials and fuse them, whereas laser welding may use a laser beam to melt the materials and form a connection.

The illustrative embodiments recognize that in some cases of battery production, a current collector with a polymer middle layer and metal outer coating may be welded to two separate metal layers that form a tab by, for example, a spot welding method that displaces a portion of the sandwiched polymer middle layer and joins both the metal outer coating of the current collector at a first surface of the current collector and a first metal layer of the tab on that surface to the metal outer coating of the current collector on an opposite surface of the current collector and the second metal layer of the tab on that opposite surface. This may form an hourglass shaped weld, comprising material of four layers (metal outer coating-first metal layer-metal outer coating-second metal layer) at the displaced portion. This displaced portion may thus be an interphase the dimensions of which may far exceed the thickness of the polymer middle layer and which horizontally squeezes out the polymer middle layer, which may accumulate and occupy extra volume leading to loss of energy density (e.g. About 5% loss in energy density), damage to the polymer current collector and tabs and reduced battery life and safety. The illustrative embodiments recognize that it is exceptionally challenging to control such polymers. Due to volume constraints in the design and fabrication of an optimal battery, it may be critical, though significantly arduous, to reduce or eliminate the loss of such volume and energy density.

The illustrative embodiments disclose a dual welding process of welding a polymer current collector to a tab on surfaces of the polymer current collector without welding through and displacing a polymer sub-layer of the polymer current collector. Thus, polymer current collector to tab connections may be formed on the surfaces of the polymer current collector and displacing of sections of the polymer sub-layer may be avoided. The polymer current collector may be a metallized polymer current collector. The illustrative embodiments disclose an article comprising an electrode including a first active material layer, a second active material layer disposed opposite the first active material layer, a metallized polymer current collector layer disposed between the first active material layer and the second active material layer. The metallized polymer current collector contacts both the first active material layer and the second active material layer, and projects beyond a first edge of the first and second active material layers. In the article, a first metal layer of a tab may be welded to a first side of the metallized polymer current collector layer, the first side including at least a portion of the metal outer coating of the metallized polymer current collector. The welding may be performed at a first welding zone. In the article, a second metal layer of the tab may be welded to a second side of the polymer current collector layer opposite the first side, the second side also including at least a portion of the metal outer coating, and the welding being performed in the first welding zone. An extension of the longer of the first and second metal layers may be welded to the shorter of the first and second metal layers at a second welding zone that is opposite the first welding zone and away from the first edge.

In one aspect the second metal layer that is welded or bonded to the bottom of the polymer current collector layer is longer than the first metal layer, though the first metal layer may alternatively be longer.

In an aspect herein, a plurality of the articles may be stacked together to form an electrode stack for a battery and the tabs for a plurality the articles may be further welded together to form a collection of tabs for a terminal of the battery.

The illustrative embodiments further disclose a method of welding components of a cell comprising providing an electrode material including a polymer current collector layer projecting beyond a first edge of the first and second active material layers. In a first welding process, a first metal layer of a tab may be welded to a first side of the polymer current collector layer and a second metal layer may be welded to a second side of the polymer current collector layer opposite the first side. In a second welding process, an extension of the longer of the metal layers of the tab may be connected at a joint with the shorter of the metal layers to form a portion of the tab that comprises a minimized thickness (e.g., a thickness of one metal tab layer as opposed to a thickness of two layers of similar lengths). The second welding process in conjunction with the first welding process of not displacing a section of the polymer sub-layer to electrically connect the metal outer coating of the polymer current collector may thus result in a tab extension that has a minimized thickness and a cell that is devoid of the so called “wrinkles” (i.e., unevenness or non-uniformity of the surface texture often accompanied by changes in height, folds in the foil or gaps in between connected material) and is relatively safe and robust.

The welding processes may be achieved by temperature and/or pressure processing techniques of applying temperature and/or pressure to one or more materials to affix them together such as roll/seam ultrasonic welding, friction roll welding, other form of roll welding/boding technique, spot ultrasonic welding or resistance welding. The welding processes may also be achieved by laser welding.

For example, ultrasonic welding may comprise using high-frequency mechanical vibrations to form a solid-state weld between two materials. This may be accomplished by subjecting the materials to high-frequency acoustic vibrations, (for example between 20 kHz and 70 kHz). The materials to be joined may be pressed together using a pressure means during ultrasonic welding as a vibrating tool known as a “horn” is positioned against them. The ultrasonic vibrations may be transmitted to the materials by the horn, softening them through frictional heat. The softened materials are then pressed together enabling them to solidify and combine into a single piece. In roll/seam ultrasonic welding as discussed herein, the ultrasonic vibrations may be applied along a seam or joint to create a continuous weld whereas in spot ultrasonic welding, the ultrasonic vibrations may be concentrated on a specific spot on the materials being joined, resulting in a localized weld. Of course, these examples and are not meant to be limiting. Other examples may be obtained in view of the descriptions herein. More generally, to avoid displacing the polymer sub-layer, the effective temperature and/or pressure used may be comparatively lower relative to that of techniques that may displace the polymer sub-layer. In an embodiment, microscopy images may be used to generated operation specifications based on material dimensions.

### Example Architecture

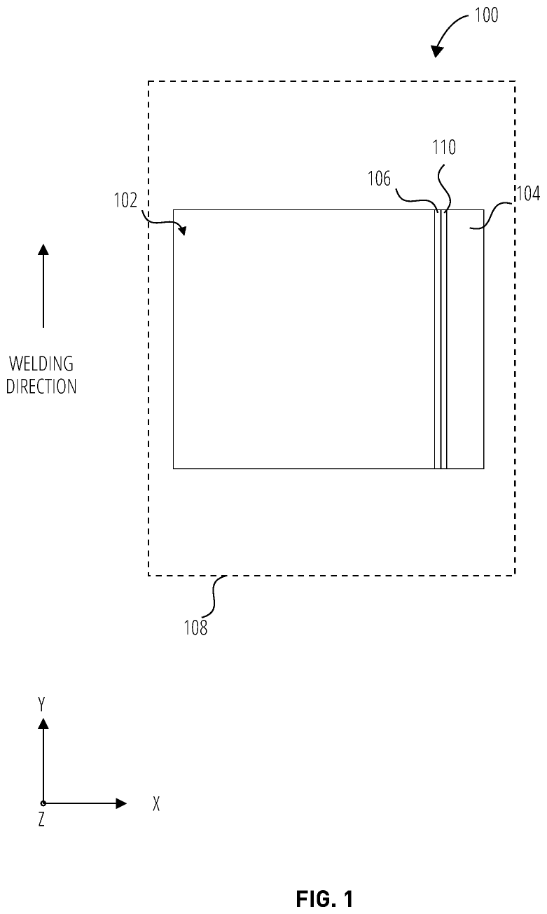

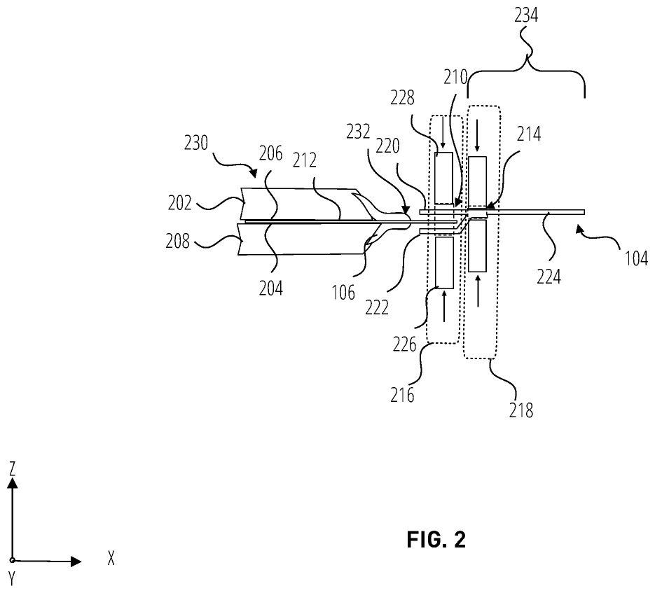

Turning now to FIG. 1, a top view of a dual welding system 100 is disclosed. The dual welding system 100 may comprise welding machine including a base plate 108 which may further include an anvil onto which the materials to be welded may be placed. The materials to be welded may include an active material layer 102 and a tab 104. A ceramic coating 106 may optionally be disposed on a side of the active material layer 102. The welding zone 110 shows an area where a polymer current collector layer 212 (shown in FIG. 2) may be welded to the tab 104.

A polymer current collector may be a type of electrode used in batteries or other electrochemical devices. The polymer current collector layer 212 may comprise conductive polymers, which may be lightweight, flexible, and can be easily processed into different shapes. In a battery, the current collector may conduct electrons between the electrode and an external circuit. The use of a polymer current collector may offer several advantages over traditional metal collectors. For example, polymer collectors can be designed to have a higher surface area, which can improve the performance of the battery and may also be less prone to corrosion, which can extend the life of the battery.

FIG. 2 illustrates a cross-section view of the dual welding system 100 showing the formation of a polymer current collector-to-tab welded connection for an article 230. The article 230 may comprise a first active material layer 202, a second active material layer 208 disposed opposite the first active material layer 202, a polymer current collector layer 212 disposed between the first active material layer 202 and the second active material layer 208, the polymer current collector layer 212 contacting both the first active material layer 202 and the second active material layer 208, and projecting beyond a first edge 232 of the first and second active material layers. The polymer current collector layer 212 extends along a first axis (e.g., X-axis) to define length, a second axis (e.g., Y-axis) orthogonal to the X-axis to define a width, and a third axis (e.g., Z-axis) orthogonal to the first and second axes to define a height.

In the article, the ceramic coating 106 may coat the first active material layer 202 and the second active material layer 208 at the first edge 232. A first metal layer 220 may be welded to a first side 206 (upper side) of the polymer current collector layer 212 at a first welding zone 210. A second metal layer 222 may be welded to a second side 204 of the polymer current collector layer 212 opposite the first side 206 at the first welding zone 210. An extension 234 of the longer (in the X-axis of FIG. 2) of the first and second metal layers may be welded to the shorter (in the X-axis) at a second welding zone 214 that is opposite the first welding zone 210, outside of an area of the polymer current collector layer 212 and on a side of first welding zone 210 that is away from the first edge 232. As an option, the extension 234 may be a third metal layer 224 that is bonded or welded to the first metal layer 220 and the second metal layer at the second welding zone 214, though this is not meant to be limiting. Further, the first metal layer 220 may comprise a same chemical composition as the second and/or third metal layer 224, though this is not meant to be limiting as they may have different chemical compositions.

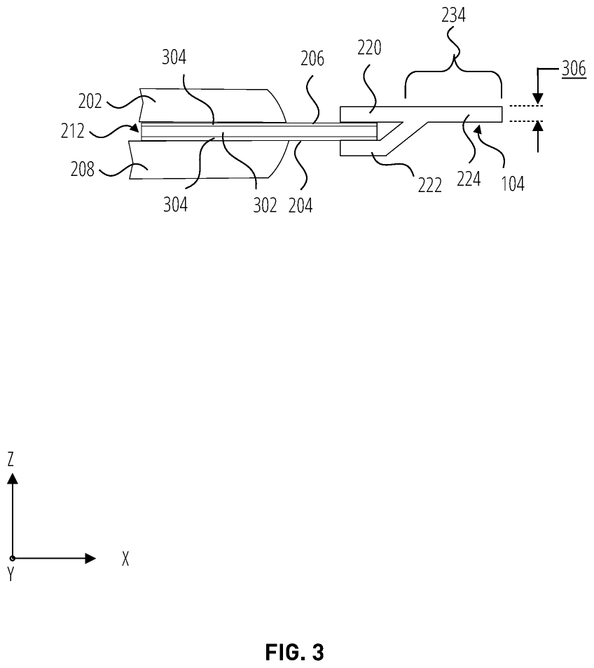

The article 230 with the polymer current collector layer 212 can be incorporated into the battery or electrochemical device after being connected to the tab 104. This connection may ensure that the electrode can transfer electrons to the external circuit effectively, enabling the device to operate as intended. As shown in the figure, the polymer current collector layer 212 and first and second metal layers of the tab 104 may be kept together during roll ultrasonic welding and vibrated at a high frequency to generate heat and friction that fuse the two materials together at the first welding zone 210. Prior to this, the first metal layer 220 and the second metal layer 222 may be separate and unconnected. A first welding device 216 comprising, for example, an anvil 226 and a horn 228, may be used to weld or bond the first metal layer 220 to the polymer current collector layer 212. Concurrently, or at another time, another welding device (or the first welding device 216) may be positioned appropriately and used to weld or bond the second metal layer 222 to the other side of the polymer current collector layer 212. The anvil may serve as a base support and the horn may generate the vibrations used to bond the materials together. Alternatively, two rollers or wheels configured to perform a more general roll bonding of the first and second metal layers to the polymer current collector at the same time in the first welding zone 210 in a roll-to-roll process may be used. The two rollers may be engaged to pass over the first metal layer, the second metal layer and the polymer current collector layer and apply pressure and/or heat while in motion. Specifications of the welding/bonding device may be preselected to ensure an optimal heat and pressure that will prevent the displacing of the polymer sub-layer 302. As is shown in more detail in FIG. 3, the joint obtained in the first zone may ensure that the metal coating 304 at the first side 206 of the polymer current collector layer 212 (the polymer current collector layer 212 may comprise the metal coating 304 and the polymer sub-layer 302) is electrically connected to the metal coating 304 at the second side 204 of the polymer current collector layer 212 when the first metal layer 220 and second metal layer 222 of the tab are finally physically and electrically connected in the second welding zone 214. For the connection at the second welding zone 214, techniques such as, but not limited to resistance welding, roll/seam ultrasonic welding, spot ultrasonic welding, laser welding, other roll bonding technique or a combination thereof may be used. Furthermore, the welding at the second welding zone 214 may occur concurrently, or at another time as the time of welding in the first welding zone 210. For example, welding in the first and second zones may be performed sequentially.

In an illustrative embodiment, the metal coating 304 may be, for example, less than 2 μm thick, in the Z-axis direction of FIG. 3, (for example from 1 μm to 2 μm thick or from 0.5 μm to 2 μm,) and the first and second metal layers may be less than 30 μm thick (for example, from 20 μm to 30 μm thick, or 10 μm to 20 μm thick or 5 μm to 30 μm,). Further, the second metal layer 222 may be less than, for example, 2 cm long in the X-axis direction of FIG. 3, (for example from 0.5 cm to 2 cm or from 1 cm to 2 cm) and the first metal layer 220 may be longer and may be, for example, less than 5 cm long (such as from 1 cm to 5 cm or from 3 cm to 5 cm). The longer metal layer (for example the second metal layer 222) may be further welded to a main tab that has a polymer sleeve and exits the cell.

Thus, a dual welding system is disclosed wherein a polymer current collector-to-tab welded connection may be formed at first welding zone 210 and at the second welding zone 214, creating a “Y” or “tongue and groove” type joint as shown in the figures. Herein, a thickness 306 of an extension 234 of the joint towards a cell terminal may be minimized due to bending of the second metal layer 222 to join the first metal layer 220 as opposed to welding two separate metal pieces of similar length together.

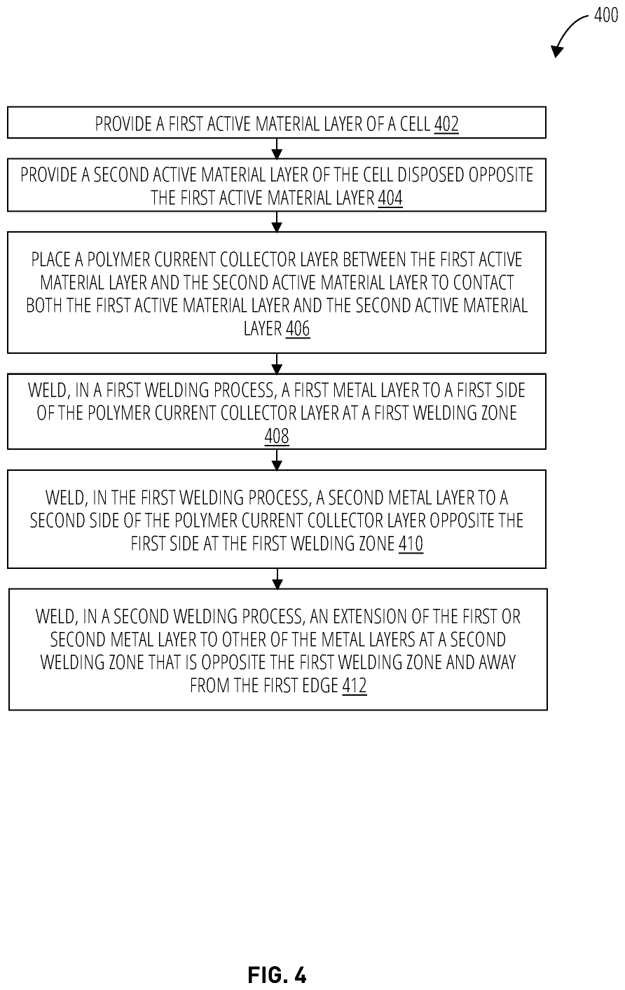

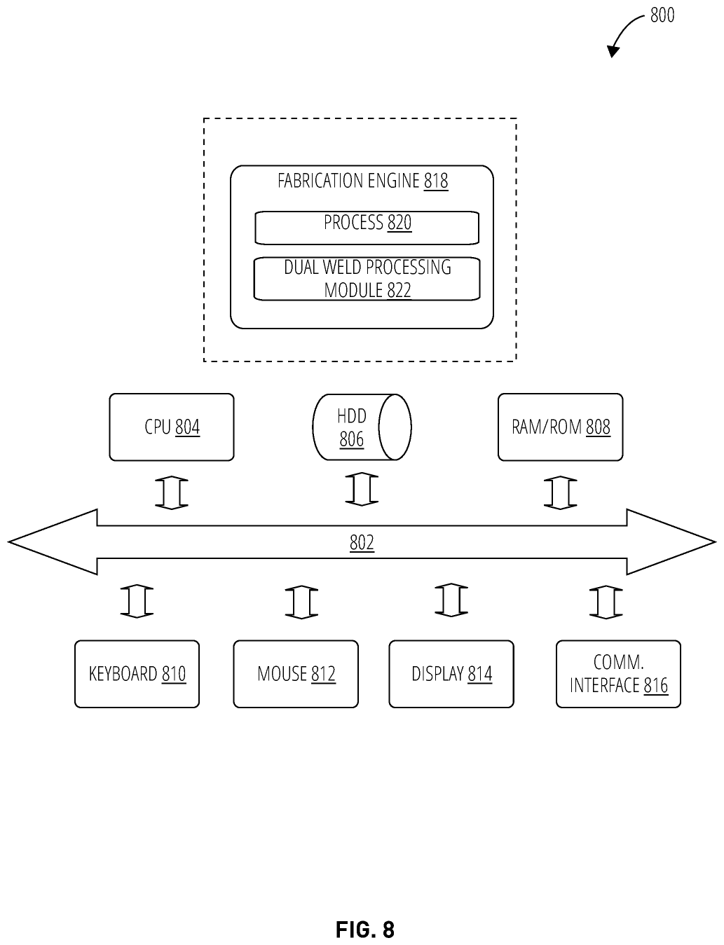

Turning, to FIG. 4, a dual welding routine 400 for welding the polymer current collector layer to a tab is illustrated. The routing may enable the welding to be performed with minimal damage to the tab and metallized polymer current collector. The dual welding routine 400 may begin at block 402, wherein dual weld processing module 822 (FIG. 8) may provide a first active material layer of a cell. In block 404, dual weld processing module 822 may provide a second active material layer of the cell disposed opposite the first active material layer. In block 406, dual weld processing module 822 may place a polymer current collector layer between the first active material layer and the second active material layer to contact both the first active material layer and the second active material layer with the polymer current collector layer projecting beyond the first edge of the first and second active material layers. In block 408, dual weld processing module 822 may weld, in a first welding process, the first metal layer 220 to the first side 206 of the polymer current collector layer at the first welding zone 210. In block 410, dual weld processing module 822 may weld, in the first welding process, the second metal layer 222 to the second side 204 of the polymer current collector layer 212 opposite the first side 206 and at the first welding zone 210. The first welding process may provide mechanical strength for the polymer current collector-to-tab connection. In block 412, dual weld processing module 822 may weld, in a second welding process and at the second welding zone 214, an extension 234 of the longer of the metal layers to the shorter of the metal layers. The extension may alternatively be a separate third metal layer 224 which may be welded to both the first metal layer 220 and the second metal layer 222 at the second welding zone 214. The first welding process and the second welding process may be performed at a same time or at different times. Further, the second welding process may be performed to join the first and second metal layers with a joint that has high mechanical strength and minimal electrical resistance.

In another aspect, the first and second metal layers form a tab that comprises a material such as aluminum, copper, nickel, chromium, and titanium. The first and second active material layers may comprise a material such as, for example, LFP, LFMP, NMC, NCA, LMO, LCO, for a cathode and anode free, graphite, graphite+SiOx mix, prelithiated graphite, prelithiated graphite+SiOx mix, copper foil coated/laminated with lithium metal for an anode. The metal coating 304 may also comprise a metal such as aluminum, copper, nickel, chromium, and titanium.

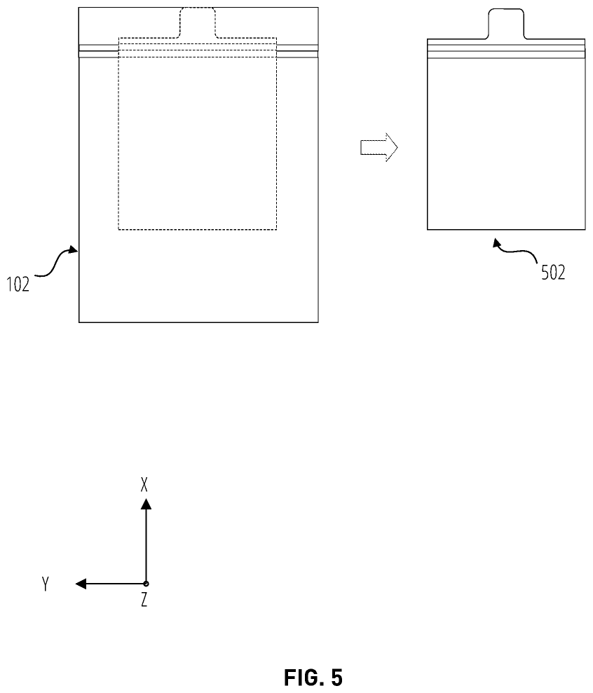

Turning now to FIG. 5, a top view of materials of FIG. 1 that are welded together is illustrated. Upon welding, an electrode 502 comprising the tab 104, the ceramic coating 106, the first active material layer 202, the second active material layer 208, and the polymer current collector layer 212 may be generated from the materials by a cutting technique, such as by laser cutting. Herein the desired shape and/or dimensions of the electrode may be utilized.

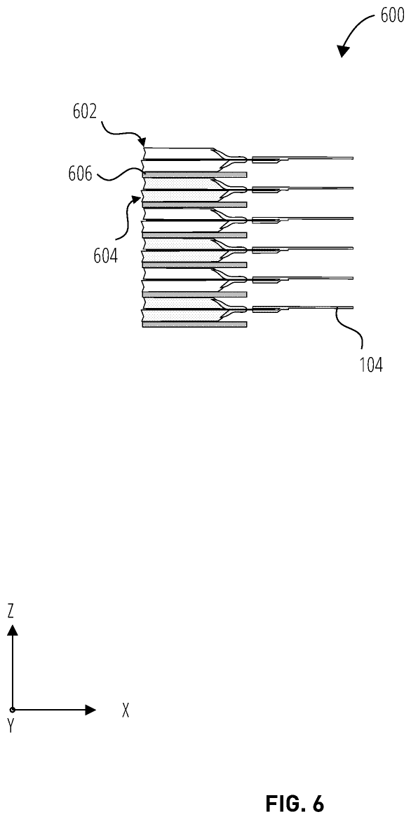

In an embodiment, as shown in FIG. 6, a plurality of electrodes arranged in a cathode 602—separator 606—anode 604 pattern may be formed to generate an electrode stack 600 for a battery. The tabs 104 of a plurality of the electrodes (e.g., of all the cathodes 602) may be joined and welded together to form a single connection that is electrically connected to a terminal of the battery (for example, to the positive terminal). By positioning the tabs of one group to be joined together away from the tabs of another group to be joined together, unintentional the touching of the tabs may be avoided.

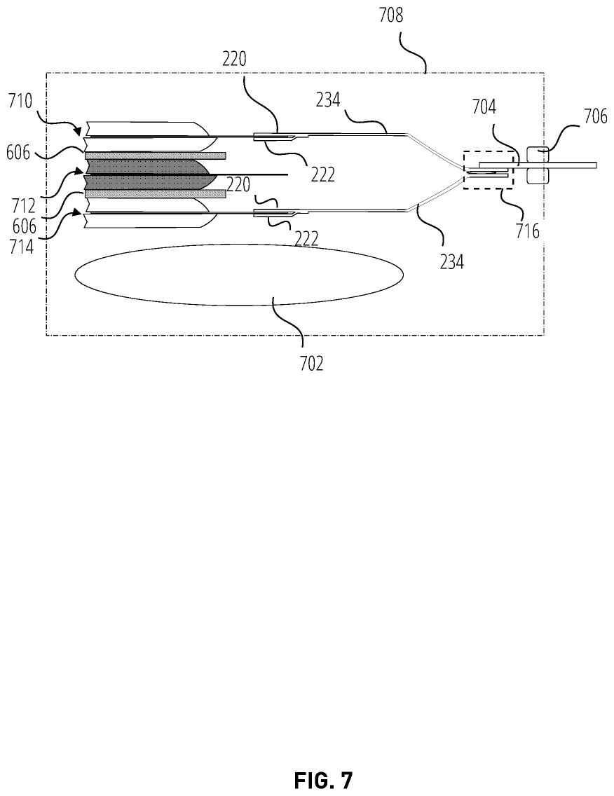

In another embodiment, as shown in FIG. 7, a pouch 708 may comprise a first cathode 710 and a first anode 712 separated by a separator 606. The first anode 712 and the second cathode 714 are be separated by a separator 606. The pouch 708 may further comprise one or more other cathode-anode stacks 702. In the figure, the tabs for the first cathode 710 and the second cathode 714 are shown wherein the tabs each comprise the first metal layer 220, the second metal layer 222 and the extension 234 of the first or second metal layer. The extensions 234 may be bended and welded or bonded together at the third welding zone 716. An effective metal tab 704 that electrically connects the first metal layers 220 and second metal layers 222 to an external portion of the pouch may also be bonded or welded to the extensions 234 at the third welding zone 716. A sealant such as a polymer may be used to seal internal contents of the pouch from the external environment.

### Example Computer Platform

As discussed above, functions relating to methods and systems for polymer current collector-to-tab dual welding can use of one or more computing devices connected for data communication via wireless or wired communication. FIG. 8 is a functional block diagram illustration of a computer hardware platform that can be used to control various aspects of a suitable computing environment in which the process discussed herein can be controlled. While a single computing device is illustrated for simplicity, it will be understood that a combination of additional computing devices, program modules, and/or combination of hardware and software can be used as well. The computer platform 800 may include a central processing unit (CPU) 804, a hard disk drive (HDD) 806, random access memory (RAM) and/or read only memory (ROM) 808, a keyboard 810, a mouse 812, a display 814, and a communication interface 816, which are connected to a system bus 802.

In one embodiment, the hard disk drive (HDD) 806, has capabilities that include storing a program that can execute various processes, such as the fabrication engine 818, in a manner described herein. The fabrication engine 818 may have various modules configured to perform different functions. For example, there may be a process module 820 configured to control the different manufacturing processes discussed herein and others. There may be a dual weld processing module 822 operative to provide instructions and control for dual welding a polymer current collector to a tab.

For the sake of brevity, conventional techniques related to making and using aspects of the invention may or may not be described in detail herein. In particular, various aspects of computing systems and specific computer programs to implement the various technical features described herein may be well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. An article comprising:
a first active material layer;
a second active material layer disposed opposite the first active material layer;
a polymer current collector layer disposed between the first active material layer and the second active material layer, contacting both the first active material layer and the second active material layer, and projecting beyond a first edge of the first and second active material layers;
a first metal layer welded to a first side of the polymer current collector layer at a first welding zone;
a second metal layer, welded to a second side of the polymer current collector layer opposite the first side at the first welding zone; and
an extension of a longer one of the first and second metal layers, welded to a shorter one of the first and second metal layers at a second welding zone that is opposite the first welding zone and on a side of the first welding zone that is away from the first edge.

2. The article of claim 1, wherein the extension is a unibody extension.

3. The article of claim 1, further comprising a ceramic coating that coats the first active material layer and the second active material layer at the first edge.

4. The article of claim 1, wherein the first metal layer and the second metal layer are welded to the polymer current collector layer at the first welding zone by roll welding to form a roll weld.

5. The article of claim 4, wherein the roll welding is a roll ultrasonic welding technique and the roll weld is a roll ultrasonic weld.

6. The article of claim 1, wherein the first metal layer and the second metal layer are welded together at the second welding zone by resistance welding, spot ultrasonic welding, roll ultrasonic welding or laser welding to form a resistance weld, a spot ultrasonic weld, a roll ultrasonic weld or a laser weld respectively.

7. The article of claim 1, wherein the first and second metal layers form a tab that comprises a material selected from the list consisting of aluminum, copper, nickel, chromium, and titanium.

8. The article of claim 1, wherein the first and second active material layers comprise a material selected from the list consisting of LFP, LFMP, NMC, NCA, LMO, LCO, for a cathode and anode free, graphite, graphite+SiOx mix, prelithiated graphite, prelithiated graphite+SiOx mix, copper foil coated/laminated with lithium metal for an anode.

9. The article of claim 1, wherein the first active material layer, the second active material layer and the polymer current collector layer form an electrode.

10. The article of claim 1, wherein the polymer current collector layer is a polymer current collector that comprises a polymer sub-layer and a metal coated at the first and second sides.

11. The article of claim 10, wherein the metal comprises a metal selected from the list consisting of aluminum, copper, nickel, chromium, and titanium.

12. A method comprising:
providing a first active material layer of a cell;
providing a second active material layer of the cell disposed opposite the first active material layer;
placing a polymer current collector layer between the first active material layer and the second active material layer to contact both the first active material layer and the second active material layer, the polymer current collector layer projecting beyond a first edge of the first and second active material layers;
welding, in a first welding process, a first metal layer to a first side of the polymer current collector layer at a first welding zone;
welding, in the first welding process, a second metal layer to a second side of the polymer current collector layer opposite the first side at the first welding zone; and
welding, in a second welding process, an extension of a longer one of the first and second metal layers to a shorter one of the first and second metal layers, at a second welding zone that is opposite the first welding zone and on a side of the first welding zone that is away from the first edge.

13. The method of claim 12, further comprising:
welding the first metal layer and the second metal layer to the polymer current collector layer at the first welding zone by roll welding to form a roll weld.

14. The method of claim 13, wherein the roll welding is a roll ultrasonic welding technique.

15. The method of claim 12, further comprising:
welding the first metal layer and the second metal layer together at the second welding zone by resistance welding, spot ultrasonic welding, roll ultrasonic welding or laser welding to form a resistance weld, a spot ultrasonic weld, a roll ultrasonic weld or a laser weld respectively.

16. The method of claim 12, wherein the first and second metal layers form a tab.

17. The method of claim 16, further comprising:
forming an electrode comprising at least the tab, the first active material layer, the second active material layer, and the polymer current collector layer by a cutting process based on a desired shape and/or dimensions of the electrode.

18. The method of claim 17, wherein a plurality of electrodes are formed and another plurality of tabs of the plurality of electrodes are joined and welded together to form a single electrical connection that is electrically connected to a terminal of the battery.

19. The method of claim 12, wherein the first welding process and the second welding process are performed concurrently.

20. The method of claim 12, wherein the first welding process and the second welding process are performed at different times.
